(19) United States
(12) Patent Application Publication
(10) Pub. No.: US 2025/0005560 A1
(43) Pub. Date: Jan. 2, 2025

(54) DIGITAL PAYMENT SOURCE VALIDATION VIA NEAREST NEIGHBOR

(71) Applicant: VeriFone, Inc., Wilmington, DE (US)

(72) Inventors: Darren Endo, Carefree, AZ (US); Jeremy Belostock, Burlingame, CA (US)

(73) Assignee: VeriFone, Inc., Wilmington, DE (US)

(21) Appl. No.: 18/703,981

(22) PCT Filed: Oct. 28, 2021
(86) PCT No.: PCT/US2021/072071

§ 371 Date: Apr. 23, 2024

(51) Int. Cl. G06Q 20/36; G06Q 20/08; G06Q 20/20; G06Q 20/22

(52) U.S. Cl. CPC G06Q 20/3674; G06Q 20/0855; G06Q 20/206; G06Q 20/227

(57) ABSTRACT

Methods and systems for authenticating transactions are provided. In response to validation information being provided to a peripheral device, the peripheral device launches a web-based service that can interrogate an initial digital payment source, e.g., a crypto-wallet and/or an exchange application to determine if the initial digital payment source meets a KYC threshold. If the KYC threshold is not met, the web-based service can interrogate other payment sources owned by the user to determine whether they have user authentication data associated with them. If other digital payment sources have user authentication data associated with them, the system can use the aggregate authentication information to validate the identity of the user for the initial payment source which can then be used to process the transaction. If there is insufficient user authentication data to validate the initial payment source, the user is prompted to complete authentication actions to satisfy the KYC threshold.

### BACKGROUND

Aspects and implementations of the present disclosure are generally directed to systems and methods for Know Your Customer (KYC) validation of digital payment sources.

As the use of cryptocurrency becomes more and more prevalent, the entities involved in processing and receiving crypto-payments, as well as regulating agencies, desire increased transparency in identifying the payor, i.e., the user attempting to use crypto currency to pay for goods or services. The desire to authenticate or identify the user/payor is also much larger when dealing with high transaction values, e.g., transactions involving at least four-figure sums. Furthermore, transaction activities using cryptocurrency are largely anonymous and are not tracked by any centralized repository, making it difficult to recall records of transactions for the purposes of providing refunds, confirmation of payment, etc.

### SUMMARY OF THE DISCLOSURE

The present disclosure is directed to methods and systems for authenticating transactions using a web-based service. In response to validation information being provided to a peripheral device, the peripheral device launches a web-based services that can interrogate one or more digital payment sources, e.g., crypto-wallets and/or crypto exchange applications to determine if the one or more digital payment sources meets a KYC threshold to process the transaction If the KYC threshold is not met, the web-based service can interrogate other payment sources owned by the user to determine whether they have user authentication data associated with them. If other digital payment sources have user authentication data associated with them, the system can use the aggregate authentication information to validate the identity of the user for the initial payment source which can then be used to process the transaction. If there is insufficient user authentication data to validate the initial payment source, the user is prompted to complete authentication actions to satisfy the KYC threshold.

The majority of crypto-wallets allow for anonymous set-up, e.g., no email address, password, or additional criteria are needed to send and receive “coins.” Most crypto-wallets set a purchase or deposit limit which may require a KYC process to be initiated for: i) the user's purchase history; ii) purchases from an exchange (e.g., fiat currency to cryptocurrency, cryptocurrency to crypto currency, etc.); iii) the user's payment type; and iv) ID verification of the user's account. These KYC processes are time consuming and are considered to induce “friction” points that disrupt a normal transactional flow process.

In one example, a system for authenticating a transaction is provide, the system including: a payment terminal or point of sale device configured to receive transaction information related to the transaction and display validation data; and a peripheral device. The peripheral device being configured to: capture validation data from the payment terminal or point of sale device; initiate a web-based service in response to capturing validation data from the payment terminal or the point of sale device; present, via the web-based service, a plurality of digital payment sources to a user via a display of the peripheral device; receive a selection, via a user input of the peripheral device, of an initial digital payment source of the plurality of digital payment sources to process a transaction associated with the validation data; in response to receipt of the selection, receive a determination by a logic layer of the web-based service whether the selected initial digital payment source is associated with a minimum threshold of user authentication criteria; and if the minimum threshold of user authentication criteria is not satisfied, i) obtain user authentication data associated with one or more secondary digital payment sources of the plurality of digital payment sources and associating the user authentication data with the initial digital payment source; or ii) prompting the user to perform one or more authentication actions.

In an aspect, the transaction includes a request to process a transaction value above a predetermined threshold value.

In an aspect, the one or more digital payment sources include one or more crypto-wallets and/or one or more digital currency exchange accounts or applications.

In an aspect, the system also includes at least one remote server or cloud-based storage device having a memory, wherein if the minimum threshold of user authentication is satisfied, the peripheral device and a payment processor are configured process the transaction, and the web-based service stores, via the memory, a transaction instance, wherein the transaction instance includes at least one of i) a transaction identification (ID), ii) identification data related to the plurality of digital payment source, and iii) meta data related to an identity of the user.

In an aspect, the memory operates to form a record keeping environment for all transactions from the user and includes a transaction number that is unique to the payment processor.

In an aspect, the memory operates to bind data related to hardware of the peripheral device to the transaction instance.

In an aspect, the logic layer of the web-based service returns a binary result indicating whether the minimum threshold of user authentication has been met.

In an aspect, the validation data is bar code or quick response (QR) code, the peripheral device comprises at least one camera, and the capturing of the validation data utilizes the at least one camera.

In an aspect, the logic layer, via at least one application program interface (API), is configured to retrieve data related to at least one of i) device hardware of the peripheral device, ii) which digital payment source of the plurality of digital payment sources has been selected, iii) and whether the peripheral device has data stored for secondary digital payment sources of the one or more digital payment sources.

In an aspect, the logic layer, via at least one application program interface (API), is configured to retrieve ancillary authentication data selected from i) user faceprint data, ii) user fingerprint data, iii) a user's personal identification number (PIN), iv) a media access control address (MAC), or any combination thereof.

In another example, a method of authenticating a transaction is provided, the method including: initiating a web-based service in response to capturing validation data from a payment terminal or a point of sale device; presenting, via the web-based service, a plurality of digital payment sources to a user via a display of a peripheral device; receiving a selection, via a user input of the peripheral device, of an initial digital payment source of the plurality of digital payment sources to process a transaction associated with the validation data; receiving a determination by a logic layer of the web-based service whether the selected initial digital payment source is associated with a minimum threshold of user authentication criteria; and if the minimum threshold of user authentication criteria is not satisfied, i) obtaining user authentication data associated with one or more secondary digital payment sources of the plurality of digital payment sources and associating the user authentication data with the initial digital payment source; or ii) prompting the user to perform one or more authentication actions.

In an aspect, the transaction includes a request to process a transaction value above a predetermined threshold value.

In an aspect, the plurality of digital payment sources include one or more crypto-wallets and/or one or more digital currency exchange accounts or applications.

In an aspect, if the minimum threshold of user authentication is satisfied, the transaction is processed and the web-based service stores, via a memory of at least one remote server or cloud-based storage device, a transaction instance, wherein the transaction instance includes at least one of i) a transaction identification (ID), ii) identification data related to the initial digital payment source, and iii) meta data related to an identity of the user.

In an aspect, the memory operates to form a record keeping environment for all transactions from the user and includes a transaction number that is unique to a third party payment processor.

In an aspect, the memory operates to bind data related to hardware of the peripheral device to the transaction instance.

In an aspect, the logic layer of the web-based service returns a binary result indicating whether the minimum threshold of user authentication has been met.

In an aspect, the logic layer, via at least one application program interface (API), is configured to retrieve data related to at least one of i) device hardware of the peripheral device, ii) which digital payment source of the plurality of digital payment sources has been selected, iii) and whether the peripheral device has data stored for secondary digital payment sources of the plurality of digital payment sources.

In an aspect, the logic layer, via at least one application program interface (API), is configured to retrieve ancillary authentication data selected from i) user faceprint data, ii) user fingerprint data, iii) a user's personal identification number (PIN), iv) a media access control address (MAC), or any combination thereof.

In another example, a method of authenticating a transaction is provided, the method including: initiating a web-based service in response to capturing a bar code or Quick Response (QR) code from a payment terminal or a point of sale device; presenting, via the web-based service, one or more crypto-wallets and/or one or more digital currency exchange accounts or applications to a user via a display of a peripheral device; receiving a selection, via a user input of the peripheral device, of the one or more crypto-wallets and/or the one or more digital currency exchange accounts or applications to process a transaction associated with the validation data; receiving a determination by a logic layer of the web-based service whether the selected one or more crypto-wallets and/or the one or more digital currency exchange accounts or applications are associated with a minimum threshold of user authentication criteria; and if the minimum threshold of user authentication criteria is not satisfied, i) obtaining user authentication data associated with one or more secondary crypto-wallets and/or one or more secondary digital currency exchange accounts or applications and associating the user authentication data with the crypto-wallet and/or the one or more digital currency exchange accounts or applications; or ii) prompting the user to perform one or more authentication actions.

These and other aspects of the various embodiments will be apparent from and elucidated with reference to the embodiment(s) described hereinafter.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the various embodiments.

FIG. 1 is a schematic view of a validation system according to the present disclosure.

FIG. 2 is a schematic representation of a peripheral device according to the present disclosure.

FIG. 3 is an illustration of a plurality of digital payment sources available to a user according to the present disclosure.

FIG. 4 is a process flow diagram according to one example of the present disclosure.

FIG. 5 is a partial process flow diagram according to one example of the present disclosure.

FIG. 6 is a partial process flow diagram according to one example of the present disclosure.

FIG. 7 is a detail partial process flow diagram of the anatomy of a transaction instances according to the present disclosure.

FIG. 8 is a flow chart illustrating example steps of a method according to the present disclosure.

FIG. 9 is a flow chart illustrating example steps of a method according to the present disclosure.

### DETAILED DESCRIPTION OF EMBODIMENTS

The present disclosure is directed to methods and systems for authenticating transactions using a web-based service. In response to validation information being provided to a peripheral device, the peripheral device launches a web-based services that can interrogate one or more digital payment sources, e.g., crypto-wallets and/or crypto exchange applications to determine if the one or more digital payment sources meets a KYC threshold to process the transaction If the KYC threshold is not met, the web-based service can interrogate other payment sources owned by the user to determine whether they have user authentication data associated with them. If other digital payment sources have user authentication data associated with them, the system can use the aggregate authentication information to validate the identity of the user for the initial payment source which can then be used to process the transaction. If there is insufficient user authentication data to validate the initial payment source, the user is prompted to complete authentication actions to satisfy the KYC threshold.

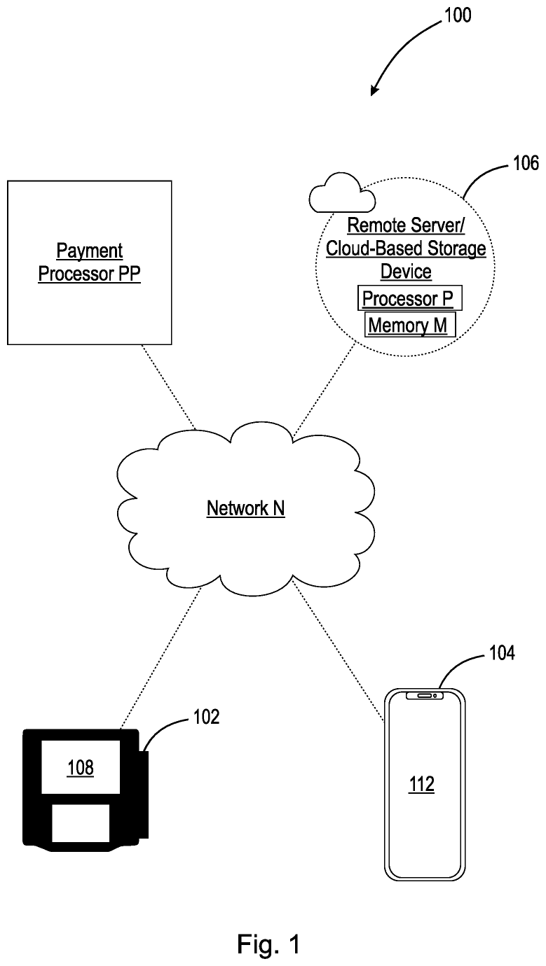

The following description should be read in view of FIGS. 1-7. FIG. 1 is a schematic view of a validation system 100 (also referred to herein as “system 100”) according to the present disclosure. As shown in FIG. 1, system 100 can include one or more payment devices, point of sale devices, or payment terminals (hereinafter referred to in the collective as “payment devices 102” and/or in the singular as “payment device 102”). Additionally, system 100 also includes a peripheral device 104, a payment processor PP, and a remote server or cloud-based storage device 106 (hereinafter referred to as “remote server 106”). Payment device 102 is configured to receive payment information from a user, e.g., a patron at a retail or dining establishment, and may transmit and/or receive payment data via a network N to and/or from a payment processor PP. Network N can be a local area network (LAN), a wide area network (WAN), a 3G network, 4G/LTE network, or may include a plurality of devices and/or servers connected over the internet. It should be appreciated that the connections within and between payment device 102 and the other devices of the network N can include wired or wireless communications. It should also be appreciated that transmission can be accomplished by any means and/or protocol of data transfer (e.g., UART, universal asynchronous receiver-transmitter protocol). Data transfer may also be accomplished by local data aggregation and batch storage via WebRTC (e.g., peer-to-peer-to-any local device) and/or via gateway service with a secure tunnel (e.g., WebRTC Leak Shield).

Payment processor PP is intended to be a third-party processor, e.g., a party other than the user of the peripheral device, the business establishment, or the provider of the payment devices, that receives payment information from user and performs or handles the financial transaction between the source of funds of the user and the destination of the funds, e.g., the bank of the business establishment. In the examples described below, the user may attempt payment via the payment device 102 and/or peripheral device 104 using digital payment sources 114 (discussed below), e.g., crypto-wallets and/or cryptocurrency exchange applications. In these examples, the payment processor PP can be configured to receive and or process transactions using cryptocurrency. As such, the payment processor PP can be a processor configured to process cryptocurrency transactions, e.g., Bitpay, Coinbase Commerce, Circle, CoinGate, Cryptopay, etc.

As illustrated in FIG. 1, payment device 102 is shown as a multilane payment device and card reader. However, it should be appreciated that payment device 102 can be selected from at least one of: a fixed or mounted Point of Sale (POS) terminal, a fixed or mounted POS device, a fixed or portable kiosk, a gas pump payment terminal or kiosk, a portable POS device or terminal, a mobile device (e.g., a tablet or smartphone), or any other device capable of reading payment data from a user's card (e.g., a credit or debit card) or reading payment data from a user's peripheral device, e.g., data related to alternative payment methods such as PayPal, Venmo, Apple Pay, Alipay, Klarna, PaySafeCard, Cryptocurrency, etc. As such, in some examples, payment device 102 includes a payment device display 108. Payment device display 108 can be a liquid crystal, LED (Light-Emitting Diode), or OLED (Organic LED), display and can include touch screen functionality. Payment device 102 can also include one or more physical inputs, e.g., a button, switch, etc., to receive a user input UI (discussed below). As will be discussed below in detail, payment device display 108 is configured to display validation data VD (discussed below) related to a pending transaction utilizing the validation system 100 discussed herein.

Peripheral device 104 is intended to be a user controlled device, e.g., a user's cellphone, smartphone, tablet, person computer, etc. As such, peripheral device 104 includes a camera 110 or other visual sensor capable of obtaining validation data VD from the payment device 102. Peripheral device 104 also includes a peripheral device display 112. Peripheral device display 112 can be a liquid crystal, LED (Light-Emitting Diode), or OLED (Organic LED), display and can include touch screen functionality. Peripheral device 104 can also include one or more physical inputs, e.g., a button, switch, etc., to receive a user input UI (discussed below).

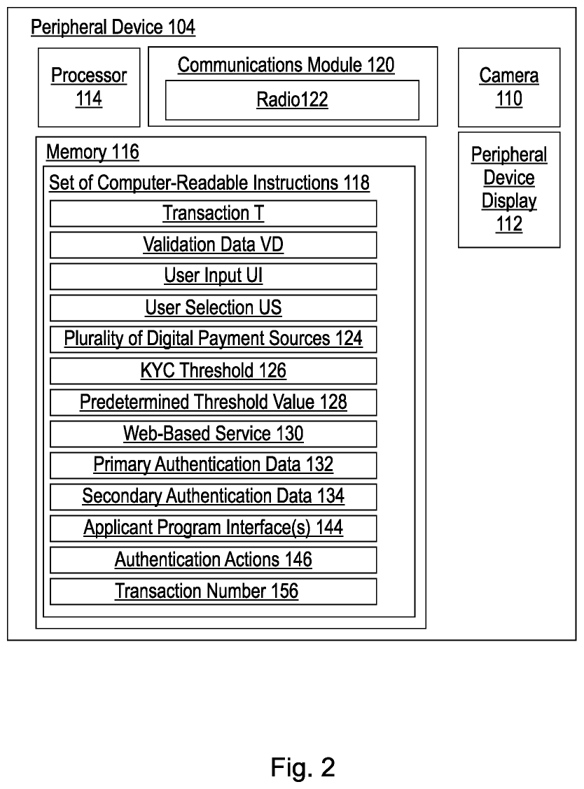

As schematically shown in FIG. 2, peripheral device 104 also includes a processor 114 and memory 116 configured to execute and store, respectively, a plurality of non-transitory computer readable-instructions 118, that when executed by the processor 114 perform the steps and/or functionality of the peripheral device 104 and/or the web-based service 130 (discussed below). To that end, peripheral device 104 can also include a communications module 120 configured to send and/or receive wireless data, e.g., data relating to a transaction T and/or user authentication data, e.g., (primary authentication data 132 and/or secondary authentication data 134 (discussed below)). As such, the communications module 120 can include at least one radio 122 or antenna capable of sending and receiving wireless data. In some examples, the communications module 120 can include, in addition to at least one some form of automated gain control (AGC), a modulator and/or demodulator, and potentially a discrete processor for bit-processing that are electrically connected to the processor and memory to aid in sending and/or receiving wireless data. In some examples, as illustrated in FIG. 1, system 100 includes a remote server 106. Remote server 106 acts as a repository or record keeping entity that will record transaction instances 148 initiated by the web-based service 130 (discussed below) so that a transaction history may be established for a particular user or device. As such, remote server 106 can include a processor P and a memory M configured to store and/or execute a set of non-transitory instructions to perform the function of the remote server 106 discussed herein.

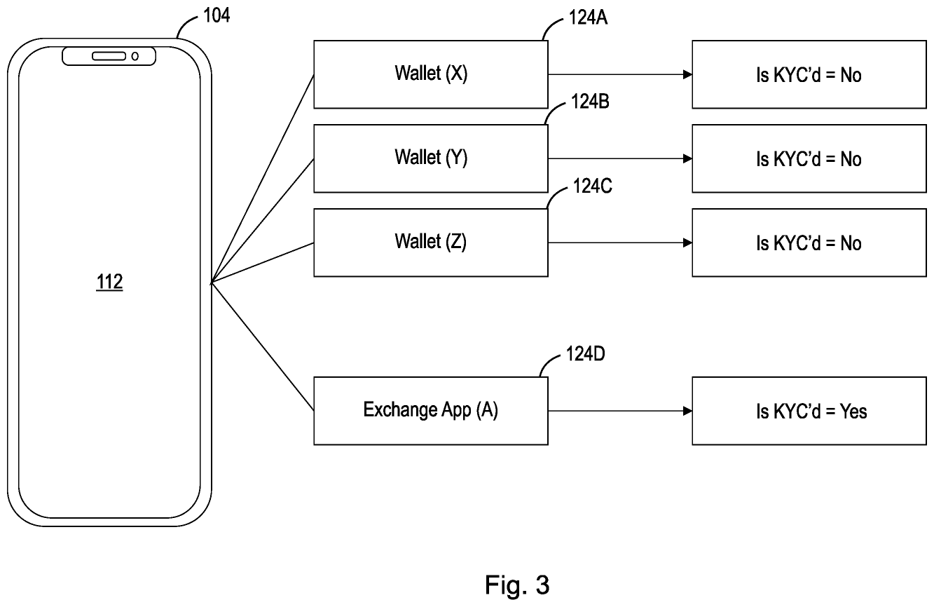

As discussed above, and as illustrated in FIG. 3, a single user can establish multiple digital payment sources 124A-124D that the user can access at any time to send or receive funds. Although four digital payment sources 124A-124D (collectively referred to herein as “plurality of digital payment sources 124” or “digital payment sources 124”). Each digital payment source 124 can be a digital wallet and/or a digital currency exchange account or application. As set forth herein, digital wallets can be a digital currency wallet for storing and accessing cryptocurrency, e.g., Coinbase Wallet, Exodus, Trust Wallet, Electrum Wallet, etc., and the digital currency exchange account, e.g., Coinbase, Coinbase Pro, Cash App, Bisq., Binance, etc. It should be appreciated that, with respect to the digital wallets, the wallets can be hot wallets (e.g., web or software wallets), cold wallets, or any other wallet that provides tools necessary to interact with a blockchain.

As mentioned above, it is desirable for each digital payment source 124 to be associated with user authentication data to a minimum level so that third-party payment processors PP and/or parties that process crypto-transactions can know to a minimum threshold of certainty the identity of the user attempting to use the digital payment source 124 to conduct a transaction. As such, the present disclosure sets forth a minimum threshold of user authentication criteria 126, that if satisfied, will allow a transaction involving the digital payment sources 124 to proceed. This minimum threshold of authentication criteria 126 may be referred to herein and within the accompanying figures as “KYC” or know your customer. Know your customer (KYC) refers to a set of standards and guidelines that can be universally applied to similar transactions to determine if the peripheral device 104 and/or each digital payment source 124 has associated a sufficient amount of user data or user authentication data to certify that the user is in fact the user associated with each digital payment source 124. The KYC standard or minimum threshold of authentication criteria 126 for processing a crypto-transaction, i.e., a transaction involving the exchange of cryptocurrency, can vary based on the amount of currency being exchanged in a given transaction, based on the third-party payment processor PP, or based on the types of goods or services that are being purchased. In one example, transactions above a predetermined threshold value 128, e.g., transaction values greater than or equal to $50.00 US Dollars can require a first level of KYC validation while low value transactions, e.g., below $50.00 US Dollars can require a second level of KYC validation lower than the first level. In one example, the predetermined threshold value 128 can be selected from within the range of $50.00-$10,000.00 US Dollars, or in certain examples the predetermined threshold value 128 is $2,000.00 US Dollars, $3,000.00 US Dollars, $5,000.00 US Dollars. It should be appreciated that the predetermined threshold value 128 can be selected from any value that is considered to be a high-value transaction as set forth by the third-party payment processor PP, and could be selected from any value greater than or equal to $50 US Dollars. It should also be appreciated that regulatory requirements may require that any transaction conducted using cryptocurrency need to meet some minimum KYC threshold 126, and therefore any transaction can require a minimum threshold to be met, i.e., the predetermined threshold value 128 can be any transaction greater than $0.01 US Dollars. As will be discussed below, at any one point in time, e.g., at the time a transaction T is being processed some of the digital payment sources 124 can meet the minimum threshold for user authentication 126 and be “KYC'ed,” while other digital payment sources 124 owned by the same user may not.

In determining whether one or more digital payment sources 124 have been KYC'ed to a sufficient degree, i.e., whether the one or more digital payment sources 124 meet the minimum threshold of user authentication 126, the peripheral device 104 can launch or otherwise execute a set of computer readable instructions to access a web-based service 130 configured to obtain data or otherwise gather information about the user and/or the user's available or selected digital payment sources 124, evaluate whether one or more digital payment sources 124 meet the minimum user authentication threshold 126 (also referred to herein as the “KYC threshold 126”), and return a binary result, e.g., a “0” indicating that one or more selected or available digital payment sources 124 do not meet the minimum KYC threshold 126 or a “1” indicating that the one or more selected or available digital payment sources 124 do meet the minimum KYC threshold 126.

In practice and/or during operation of system 100, a user, when attempting to pay for or process a transaction T using cryptocurrency, for example, will interact with a business establishment to initiate a transaction instance for a transaction T. As a part of the transaction T, the user may indicate by some user input UI a user selection US of one of digital payment source 124 of the plurality of digital payment sources 124 that they would like to process the transaction using. Should the business establishment, the third-party payment processor PP, or the particular host of the crypto-wallet or exchange application used by the user require that a minimum KYC threshold 126 be met to proceed with the transaction, the payment device 102 can display, via payment device display 108 (discussed above), validation data VD. Validation data VD can be machine-generated data and can be represented by a visual pattern of black and white (or other high-contrast colors) spatially defined portions that will allow a machine-based visual sensor, e.g., camera 110 of peripheral device 104 to obtain the validation data VD, process the image data of the validation data VD, and use the processed data to trigger the launch or execution of web-based service 130. As such, the validation data VD can be presented as a bar code, quick response (QR) code, or other machine-generated or machine-readable data set capable of storing triggering information and/or a Uniform Resource Locator (URL) for the web-based service along with other executable data that would instruct peripheral device 104 to launch a web browser and navigate to the URL associated with the web-based service 130. It should be appreciated that web-based service 130 can also be launched manually, e.g., by the user manually navigating (e.g., via the touch-screen display of peripheral device display 108 or via one or more buttons of peripheral device 104) to a URL associated with the web-based service 130.

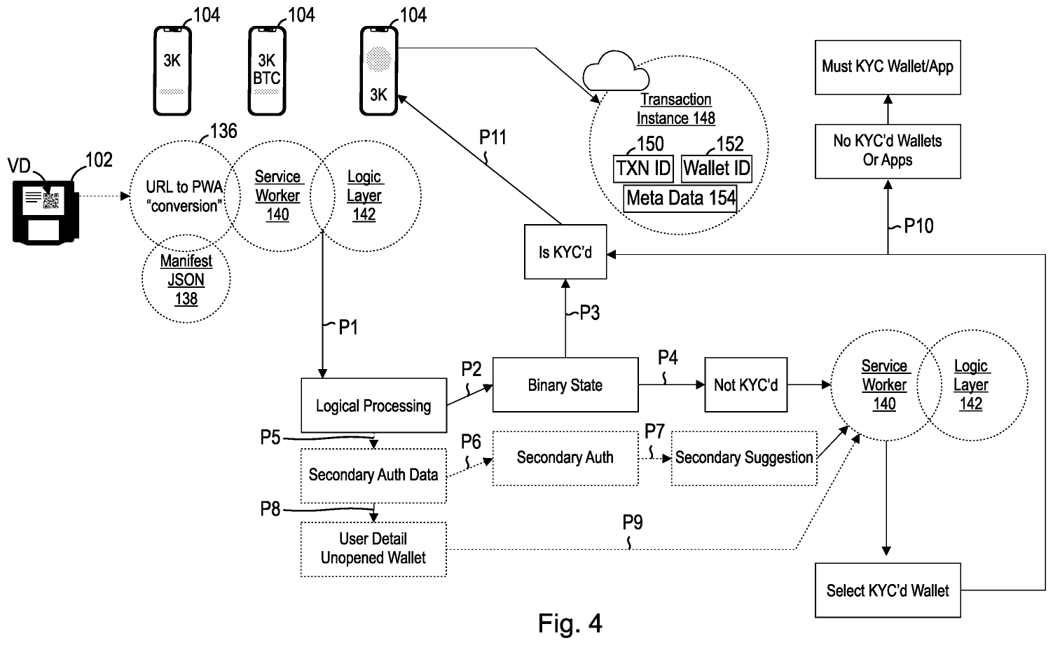

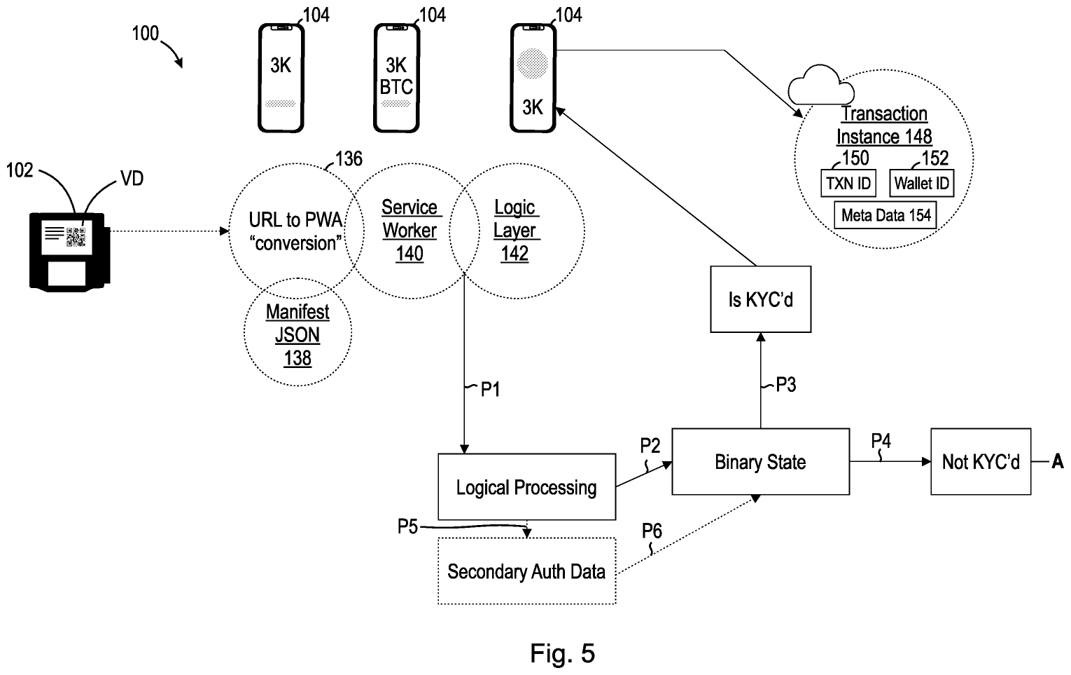

As shown in FIGS. 4-5, after the peripheral device 104 scans and processes the validation data VD displayed on the payment device display 108, the peripheral device 104 can launch a web browser using a web URL, which launches a progressive web application (PWA) 136 and uses a manifest JavaScript Object Notation (JSON) or a manifest.json file 138 to define the parameters of the PWA 136 when launched. The JSON file 138 instructs a web-based service worker 140 of the PWA to scan the hardware of the peripheral device 104 and/or determine what wallets (if any) are opened and what other wallets are available on the device. If the service worker 140 does not already have access to this information, the service worker can generate an application program interface (API) call via a secure socket communication to query that information. The service worker may employ a logic layer 142 to perform logical processing of the authentication data available to the PWA 136 and/or the service worker 140 to determine whether any particular wallet or exchange application is KYC'ed to an acceptable level or threshold and can return a binary result informing the service worker 140 that one or more wallets are sufficiently KYC'ed. As will be discussed below, the service worker 140 and/or logic layer 142 can also utilize secondary authentication data 134 to further inform the logical processing as to whether a particular wallet or exchange application is KYC'ed to the minimum KYC threshold 126.

As discussed above, web-based service 130 and/or service worker 140 may execute one or more application program interfaces (APIs) 144 that are configured to query certain data from the user's peripheral device 104. For example, in evaluating whether a KYC threshold 126 for a particular crypto-wallet or exchange application is met, one or more APIs 144 can obtain primary authentication data 132, e.g., the one or more APIs 144 can: obtain device hardware information of the peripheral device 104, determine which digital payment source 124 of the one or more digital payment sources 124 has been selected by the user (discussed below), determining whether the peripheral device 104 has data stored for other digital payment sources 124 of the one or more digital payment sources 124, obtain a transaction history stored in memory 116 and/or in remote service 106. Additionally, in some examples (discussed below), the APIs 144 can query or obtain secondary authentication data 134, e.g., the one or more APIs 144 can: obtain user faceprint data stored on memory 116 of peripheral device 104, obtain user fingerprint data stored on memory 116 of peripheral device 104, obtain a user's personal identification number (PIN) stored on memory 116 of peripheral device, obtain a media access control address (MAC) of the peripheral device 104, or any combination thereof.

In some examples, discussed below, in the event the KYC threshold 126 is not met and there are no other available alternatives, the web-based service 130 can request that the user perform one or more authentication actions 146 to satisfy the KYC threshold 126 for one or more respective digital payment sources 124. The authentication actions 146 can include any activity or act of data gathering data that would increase the level of KYC of one or more digital payment sources 124, e.g., the authentication actions 146 can be selected from at least one of: obtaining the user's email address, obtaining the user's phone number, prompting the user to scan a copy of the user's drivers license, prompting the user to scan a copy of the user's passport or other photo ID, prompting the user to take a photograph of their own face via the camera 110 of peripheral device 104, obtain fingerprint data using one or more sensors on the peripheral device 104, obtaining faceprint data using one or more sensors on the peripheral device 104, obtain a user's password or other data related to multi-factor authentication.

In the event transaction T is authorized, and for the purpose of forensic analysis of a user's transaction history, system 100 can utilize the record keeping environment of remote server 106 to record data relating to the processed transaction T. For example, in the event transaction T is authorized, the user will be notified, e.g., by a notification sent to and displayed by peripheral device 104, and the web-service 130 can create a transaction instance 148 in the record keeping environment of remote server 106 that can include a transaction ID number 150 specific to the transaction T, an identification 152 of the digital payment source 124 used in the transaction T, meta data 154 containing any primary authentication data 132 or secondary authentication data 134 used to determine the satisfaction of the KYC threshold 126, and a transaction number 156 that is unique to the third-party processor PP. The record keeping environment, particularly the stored data related to each specific transaction instance 148 can be used later to process refunds, confirm payments, or other forensic data gathering activities after the transaction has been authorized. It should be appreciated that the record keeping environment of the remote server 106 can utilize smart contracts that can be stored on the remote server 106 and/or can be stored directly on the blockchain that are automatically executed when predetermined terms and conditions are met.

FIG. 4 illustrates one example embodiment of system 100 according to the present disclosure. As shown in FIG. 3, a user may have established a plurality of digital payment sources 124, e.g., crypto-wallets 124A-124C (i.e., wallets X-Z) and a crypto exchange application 124D (i.e., Exchange App A). Of those digital payment sources 124, wallets 124A-124C have not been KYC'ed and exchange application 124D has been KYC'ed. The user may then indicate via the payment device 102 or indicate to an attendant at a business establishment that they would like to process a transaction T using one or more of the digital payment sources 124 to pay for goods or services. In some examples, the transaction may be processed directly without evaluating whether the transaction T includes an exchange of value over a predetermined threshold value, e.g., over $3,000.00 US Dollars. In this example, transactions greater than or equal to that predetermined threshold (i.e., $3,000.00 US Dollars) are flagged by a third-party payment processor PP to require the satisfaction of a minimum threshold of user authentication criteria 126 before the payment can be processed. In this example, the payment device 102 can present or display, using payment device display 108, a visual manifestation of validation data VD, e.g., a quick response (QR) code. The user can then scan or capture, one or more images using camera 110 of the user's peripheral device 104, the validation data VD, which automatically launches a web-based service 130 to allow the user to provide authentication information to determine whether the user has associated one or more digital payment sources 124 that would satisfy the KYC threshold 126 for transactions above the $3,000.00 US Dollar threshold.

Upon launching web-based service 130, the peripheral device 104 can prompt the user, via peripheral device display 112, to select one digital payment source 124 of the plurality of digital payment sources 124A-124D associated with the user. The user then provides a user selection US via a user input UI (shown in FIG. 2) to select a single digital payment source 124 to process the transaction T. Once selected, a progressive web application (PWA) 136, launched in response to processing the validation data VD, uses a manifest JavaScript Object Notation (JSON) or a “manifest.json” file 138 to define the parameters of the PWA 136. The JSON file 138 instructs a web-based service worker 140 of the PWA to scan the hardware of the peripheral device 104 and/or determine what wallets (if any) are opened and what other wallets are available on the device. Here, the service worker will return that the user has selected a digital wallet, e.g., digital payment source 124A (Wallet (X)), and will return that the user has three additional payment sources 124 (e.g., sources 124B-124D). The service worker 140 then generates one or more API calls via a secure socket communication using one or more APIs 144 (shown in FIG. 2) to query additional information about the user's device or the user's identity.

Along path P1 (shown in FIG. 4), the service worker 140 can employ a logic layer 142 to perform logical processing of primary authentication data 132 available to the PWA 136 and/or the service worker 140 to determine whether any particular wallet or exchange application is KYC'ed to an acceptable level or threshold and can return a binary result (along path P3) informing the service worker 140 that one or more wallets are sufficiently KYC'ed. As set forth above, the logic employed by the logic layer 142 to determine whether there is a sufficient quality and/or quantity of user authentication data identifying the user can be dependent on the amount of currency being exchanged in a given transaction, based on the third-party payment processor PP, or based on the types of goods or services that are being purchased. If sufficient primary authentication data 132 is present, the process can proceed along path P2 and return a binary state indicating that the selected digital payment source 124A meets the KYC threshold 126 or does not meet the KYC threshold. If the threshold is met the process can proceed to payment processing through path P3 (discussed further below). If the threshold has not been met the process proceeds down path P4.

Conversely, should there be insufficient primary authentication data 132 (obtained along path P1) for the selected payment source 124A to meet the KYC threshold 126, the process can proceed along optional path P5 where the service worker 140 and/or the logic layer 142 can, via one or more API calls, attempt to obtain secondary authentication data 134 to provide more information related to the identity of the user. The secondary authentication data 134 can further inform the determination made by the service worker 140 and/or the logic layer 142 along path P6 as to whether the user is, in fact, the user, and can be a factor in the binary state decision returned by the logic layer 142 as to whether the KYC threshold 126 has been met for the selected digital payment source 124A. Along path P7 the logic layer 142 can provide a suggestion as to another potential payment source 124 that would likely mee the KYC threshold 126.

As a further optional step, the process may also proceed along paths P8 and P9 and query any other user payment sources 124 associated with the user, e.g., one or more unopened wallets or exchange apps (i.e., Wallets Y-Z and Exchange App A shown in FIG. 3) to determine whether any of those wallets meet the KYC threshold 126. That information can be provided to the service worker 140 and/or the logic layer 142 which can automatically select and/or switch to using the one or more other payment sources 124 to process the current transaction T. In other words, if the selected digital payment source 124A does not meet the KYC threshold 126, the logic layer 142 can return data related to other digital payment sources 124B-124D associated with the user, and if any of those payment sources 124B-124D meet the KYC threshold 126, the system can automatically switch to using any one of the other payment sources 124B-124D to process the transaction. It should also be appreciated that the service worker 140 and/or the logic layer 142 can provide a prompt to the user, e.g., via the peripheral device display 112, to prompt the user to select one or more of the other payment sources 124B-124D, where the prompt can indicate which of the other payment sources 124B-124D would meet the KYC threshold 126. Additionally, if the selected digital payment source 124A fails to meet the KYC threshold 126, and none of the other digital payment sources 124B-124D meet the KYC threshold 126 for the transaction T, the user can be prompted, along path P10 to perform one or more authentication actions 146 to increase the collective user authentication data and meet the KYC threshold 126.

Once the selected wallet (e.g., Wallet (X)) has met the KYC threshold 126, the user selects another payment source that does meet the KYC threshold 126, or the user has performed authentication actions 146 to ensure that the selected digital payment source 124 meets the KYC threshold 126, the transaction T is processed along path P11. Once the transaction has been processed, the remote server 106 generates a transaction instance 148 that can include a transaction ID number 150, the wallet ID 152 (or exchange app ID 152) of the digital payment source 124 that met the KYC threshold 126 and was used to complete the transaction T, and/or meta data 154 related to the primary authentication data 132 or secondary authentication data 134 used to make the determination that the selected payment source meets the KYC threshold 126. Although not shown, the transaction instance 148 can also include a transaction number 156 that is unique to the third-party payment processor PP. As mentioned above, the transaction instance 148 can be stored directly in the blockchain or in remote storage via one or more smart contracts, or may be stored directly as readable data.

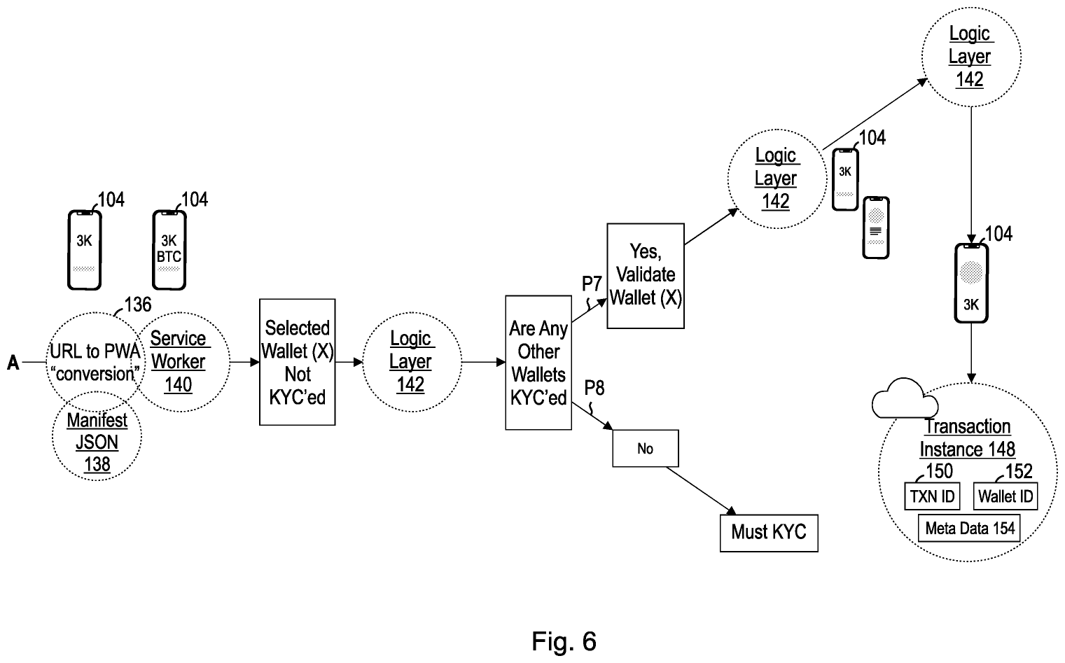

FIGS. 5 and 6 illustrate another example embodiment of system 100 according to the present disclosure. As shown in FIG. 3, a user may have established a plurality of digital payment sources 124, e.g., crypto-wallets 124A-124C (i.e., wallets X-Z) and a crypto exchange application 124D (i.e., Exchange App A). Of those digital payment sources 124, wallets 124A-124C have not been KYC'ed and exchange application 124D has been KYC'ed. The user may then indicate via the payment device 102 or indicate to an attendant at a business establishment that they would like to process a transaction T using one or more of the digital payment sources 124 to pay for goods or services. In some examples, the transaction may be processed directly without evaluating whether the transaction T includes an exchange of value over a predetermined threshold value, e.g., over $3,000.00 US Dollars. In this example, transactions greater than or equal to that predetermined threshold (i.e., $3,000.00 US Dollars) are flagged by a third-party payment processor PP to require the satisfaction of a minimum threshold of user authentication criteria 126 before the payment can be processed. In this example, the payment device 102 can present or display, using payment device display 108, a visual manifestation of validation data VD, e.g., a quick response (QR) code. The user can then scan or capture, one or more images using camera 110 of the user's peripheral device 104, the validation data VD, which automatically launches a web-based service 130 to allow the user to provide authentication information to determine whether the user has associated one or more digital payment sources 124 that would satisfy the KYC threshold 126 for transactions above the $3,000.00 US Dollar threshold (or any other monetary threshold).

Upon launching web-based service 130, the peripheral device 104 can prompt the user, via peripheral device display 112, to select one digital payment source 124 of the plurality of digital payment sources 124A-124D associated with the user. The user then provides a user selection US via a user input UI (shown in FIG. 2) to select a single digital payment source 124 to process the transaction T. Once selected, a progressive web application (PWA) 136, launched in response to processing the validation data VD, uses a manifest JavaScript Object Notation (JSON) or a “manifest.json” file 138 to define the parameters of the PWA 136. The JSON file 138 instructs a web-based service worker 140 of the PWA to scan the hardware of the peripheral device 104 and/or determine what wallets (if any) are opened and what other wallets are available on the device. Here, the service worker will return that the user has selected a digital wallet, e.g., digital payment source 124A (Wallet (X)), and will return that the user has three additional payment sources 124 (e.g., sources 124B-124D). The service worker 140 then generates one or more API calls via a secure socket communication using one or more APIs 144 (shown in FIG. 2) to query additional information about the user's device or the user's identity.

Along path P1 (shown in FIG. 5), the service worker 140 can employ a logic layer 142 to perform logical processing of primary authentication data 132 available to the PWA 136 and/or the service worker 140 to determine whether any particular wallet or exchange application is KYC'ed to an acceptable level or threshold and can return a binary result (along path P3) informing the service worker 140 that one or more wallets are sufficiently KYC'ed. As set forth above, the logic employed by the logic layer 142 to determine whether there is a sufficient quality and/or quantity of user authentication data identifying the user can be dependent on the amount of currency being exchanged in a given transaction, based on the third-party payment processor PP, or based on the types of goods or services that are being purchased. If sufficient primary authentication data 132 is present, the process can proceed along path P2 and return a binary state indicating that the selected digital payment source 124A meets the KYC threshold 126 or does not meet the KYC threshold. If the threshold is met, the process can proceed to payment processing through path P3 (discussed further below). If the threshold has not been met the process proceeds down path P4.

Conversely, should there be insufficient primary authentication data 132 (obtained along path P1) for the selected payment source 124A to meet the KYC threshold 126, the process can proceed along optional path P5 where the service worker 140 and/or the logic layer 142 can, via one or more API calls, attempt to obtain secondary authentication data 134 to provide more information related to the identity of the user. The secondary authentication data 134 can further inform the determination made by the service worker 140 and/or the logic layer 142 along path P6 as to whether the user is, in fact, the user, and can be a factor in the binary state decision returned by the logic layer 142 as to whether the KYC threshold 126 has been met for the selected digital payment source 124A.

If the selected digital payment source 124A does not meet the KYC threshold 126 (with or without the additional secondary authentication data 134), the process can proceed along path P4 and connector A and attempt to validate the selected digital payment source 124A via other ancillary data associated with the other digital payment sources 124B-124D also associated with the user. For example, the user may have one or more unopened wallets or exchange apps (i.e., Wallets Y-Z and Exchange App A shown in FIG. 3 that primary authentication data 132 and/or secondary authentication data 134 associated with each wallet or app, that, in the aggregate, if associated with a single selected wallet or app, would cause the selected wallet or app to meet the KYC threshold 126. As shown in FIG. 6, the service worker 140 returns that the selected digital payment source 124A (i.e., Wallet (X)), does not meet the KYC threshold 126, the logic layer 142 can query, via one or more API calls, the user's peripheral device 104 and/or the user's other available accounts or wallets to determine if any of the other digital payment sources 124B-124D have any user authentication data associated with them, e.g., primary authentication data 132 and/or secondary authentication data 134. If there is other user authentication data, the service worker 140 and/or the logic layer 142 can proceed down path P7 and attempt to aggregate the authentication data that is available for the user and/or available across all digital payment sources 124 to validate that the selected digital payment source 124A is associated with a user that has performed enough KYC actions across all digital payment sources in the aggregate, that the use of the selected digital payment source 124A meets the KYC threshold 126 because it is also associated with the same user. The use of authentication data associated with other digital payment sources, e.g., digital payment sources 124B-124D, to validate the KYC status of the selected digital payment source, e.g., digital payment source 124A, is herein referred to as KYC validation via the nearest neighbor. In the event that there is insufficient user authentication data associated with the other digital payment sources 124B-124D such that in the aggregate there is insufficient data to KYC the user should all of the authentication data be pooled to the selected payment source, the process proceeds along path P8 and the user is prompted to perform one or more authentication actions 146 before they are permitted to proceed with using any of the associated digital payment sources 124.

As shown in FIGS. 5 and 6, once the selected wallet (e.g., Wallet (X)) has been validated the KYC threshold 126 or the user has performed authentication actions 146 to ensure that the selected digital payment source 124 meets the KYC threshold 126, the transaction T is processed and completed via a third-party payment processor PP. Once the transaction has been processed, the remote server 106 generates a transaction instance 148 that can include a transaction ID number 150, the wallet ID 152 (or exchange app ID 152) of the digital payment source 124 that met the KYC threshold 126 and was used to complete the transaction T, and/or meta data 154 related to the primary authentication data 132 or secondary authentication data 134 used to make the determination that the selected payment source meets the KYC threshold 126. Although not shown, the transaction instance 148 can also include a transaction number 156 that is unique to the third-party payment processor PP. As mentioned above, the transaction instance 148 can be stored in the blockchain or in remote storage via one or more smart contracts, or may be stored directly as readable data.

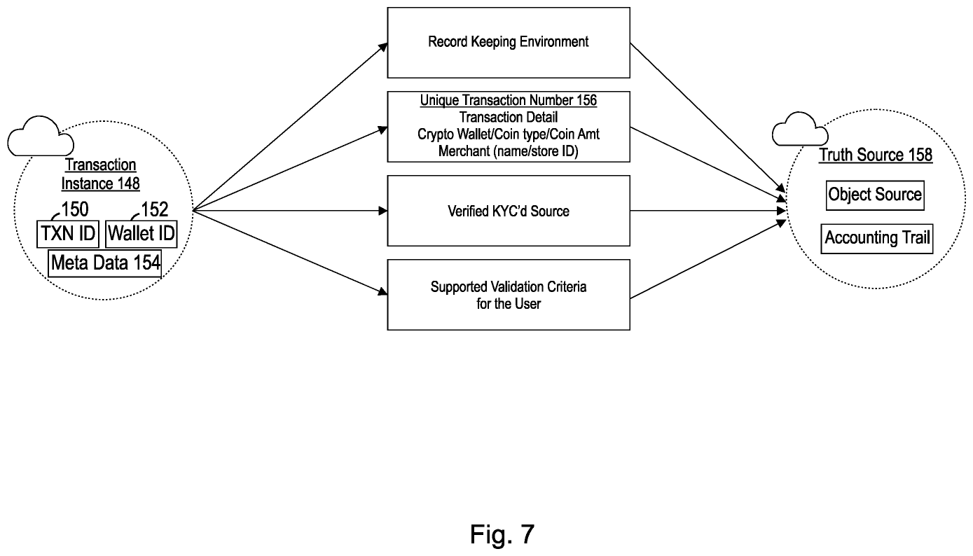

FIG. 7 illustrates a schematic illustration of the transaction instances 148 and the potential sources of data and data formats for storing data related to particular instances so that they can be recalled or audited at a later date. As shown, the data attached to each transaction instance 148 can take the form of a record keeping environment that could leverage smart contracts and could be stored directly in the blockchain. The data can also be generated by a third-party payment processor PP, e.g., a third-party crypto-processor (e.g., Bitpay), and can include a unique transaction number 156 that is unique to the third-party processor PP. Along with the unique transaction number 156, the third-party payment processor PP can store details of the transaction, data relating to the wallet or other payment source used for the transaction instance 148, what currency type was used in the transaction, the amount of currency exchanged in the transaction, and the merchant's information, e.g., the store ID or name of the store. Information related to the user's KYC'ed digital payment source that has been verified can be stored along with the transaction instance 148. Additionally, means can be provided to bind the hardware of the peripheral device 104 to the transaction instance 148 so that it may be recalled at a later point in time. Each of these data types and/or storage methods can work together in the aggregate and can work to form one or more nodes or sources of truth 158 that together can operate to aggregate several sources of user validation. The aggregation of the user's transaction details can be used to validate future transactions and can operate to prevent relatively small changes in user data to stop a transaction. For example, if a user changes device's the aggregate data stored in relation to the sources of truth for that user may only change slightly, e.g., the user's MAC address may change, but all other sources of truth identifying that user would remain the same and operate, in the aggregate to validate that user's identity.

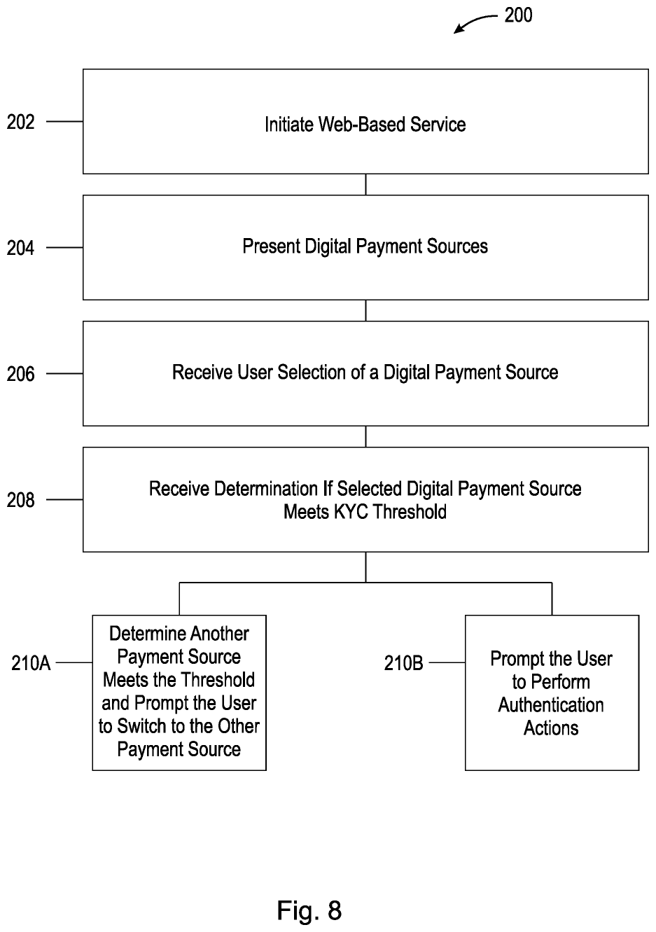

FIG. 8 is a flow chart illustrating the steps of method 200 according to the present disclosure. Method 200 can include, for example, initiating a web-based service 130 in response to capturing validation data VD from a payment terminal or a point of sale device 102 (step 202); presenting, via the web-based service 130, one or more digital payment sources 124 to a user via a display 112 of a peripheral device 104 (step 204); receiving a selection US, via a user input UI of the peripheral device 104, of a digital payment source 124A of the one or more digital payment sources 124 to process a transaction T associated with the validation data VD (step 206); receiving a determination by a logic layer 142 of the web-based service 130 whether the selected digital payment source 124A is associated with a minimum threshold of user authentication criteria 126 (step 208); and if the minimum threshold of user authentication criteria 126 is not satisfied i) determine if another digital payment source 124B-124D of the one or more digital payment sources 124 meets the minimum threshold of user authentication 126 and prompt the user to select the other digital payment source (124B-124D) (step 210A), or ii) prompt the user to perform one or more authentication actions 146 (step 210B).

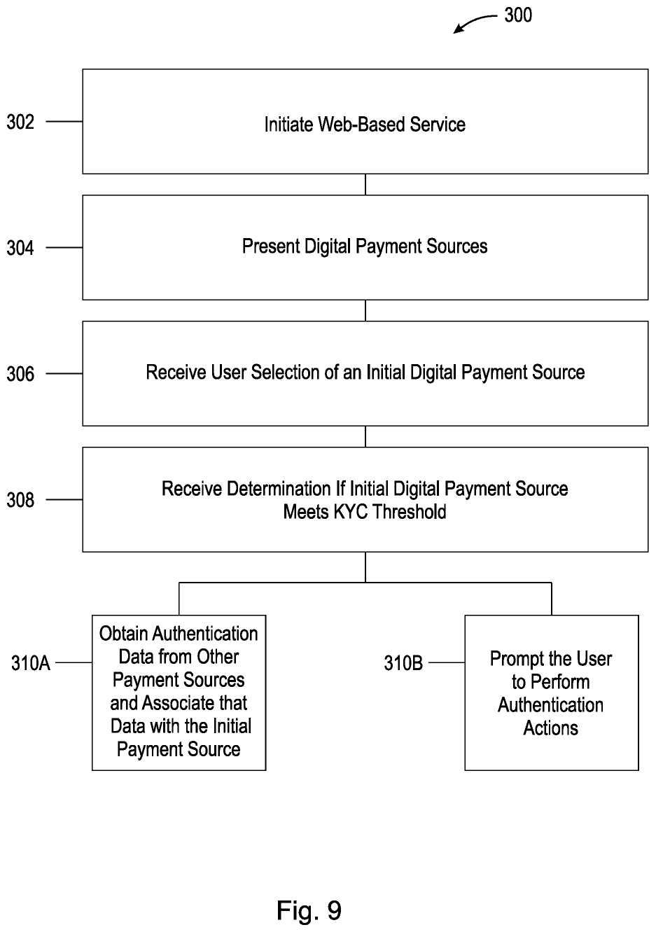

FIG. 9 is a flow chart illustrating the steps of method 300 according to the present disclosure. Method 300 can include, for example, initiating a web-based service 130 in response to capturing validation data VD from a payment terminal or a point of sale device 102 (step 302); presenting, via the web-based service 130, a plurality of digital payment sources 124 to a user via a display 112 of a peripheral device 104 (step 304); receiving a selection US, via a user input UI of the peripheral device 104, of an initial digital payment source 124A of the plurality of digital payment sources 124 to process a transaction T associated with the validation data VD (step 306); receiving a determination by a logic layer 142 of the web-based service 130 whether selected the initial digital payment source 124A is associated with a minimum threshold of user authentication criteria 126 (step 308); and if the minimum threshold of user authentication criteria 126 is not satisfied, i) obtaining user authentication data associated with one or more secondary digital payment sources 124B-124D of the plurality of digital payment sources 124 and associating the user authentication data with the initial digital payment source 124A (step 310A); or ii) prompting the user to perform one or more authentication actions 146 (step 310B).

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

The above-described examples of the described subject matter can be implemented in any of numerous ways. For example, some aspects may be implemented using hardware, software or a combination thereof. When any aspect is implemented at least in part in software, the software code can be executed on any suitable processor or collection of processors, whether provided in a single device or computer or distributed among multiple devices/computers.

The present disclosure may be implemented as a system, a method, and/or a computer program product at any possible technical detail level of integration. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some examples, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to examples of the disclosure. It will be understood that each block of the flowchart illustrations and/or block diagrams, and combinations of blocks in the flowchart illustrations and/or block diagrams, can be implemented by computer readable program instructions.

The computer readable program instructions may be provided to a processor of a, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various examples of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Other implementations are within the scope of the following claims and other claims to which the applicant may be entitled. While various examples have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the examples described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific examples described herein. It is, therefore, to be understood that the foregoing examples are presented by way of example only and that, within the scope of the appended claims and equivalents thereto, examples may be practiced otherwise than as specifically described and claimed. Examples of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

What is claimed is:

1. A system for authenticating a transaction, comprising:
a payment terminal or point of sale device configured to receive transaction information related to the transaction and display validation data; and
a peripheral device configured to:
capture validation data from the payment terminal or point of sale device;
initiate a web-based service in response to capturing validation data from the payment terminal or the point of sale device;
present, via the web-based service, a plurality of digital payment sources to a user via a display of the peripheral device;
receive a selection, via a user input of the peripheral device, of an initial digital payment source of the plurality of digital payment sources to process a transaction associated with the validation data;
in response to receipt of the selection, receive a determination by a logic layer of the web-based service whether the selected initial digital payment source is associated with a minimum threshold of user authentication criteria; and
if the minimum threshold of user authentication criteria is not satisfied, i) obtain user authentication data associated with one or more secondary digital payment sources of the plurality of digital payment sources and associating the user authentication data with the initial digital payment source; or ii) prompting the user to perform one or more authentication actions.

2. The system of claim 1, wherein the transaction includes a request to process a transaction value above a predetermined threshold value.

3. The system of claim 1, wherein the one or more digital payment sources include one or more crypto-wallets and/or one or more digital currency exchange accounts or applications.

4. The system of claim 1 further comprising at least one remote server or cloud-based storage device having a memory, wherein if the minimum threshold of user authentication is satisfied, the peripheral device and a payment processor are configured process the transaction, and the web-based service stores, via the memory, a transaction instance, wherein the transaction instance includes at least one of i) a transaction identification (ID), ii) identification data related to the plurality of digital payment source, and iii) meta data related to an identity of the user.

5. The system of claim 4, wherein the memory operates to form a record keeping environment for all transactions from the user and includes a transaction number that is unique to the payment processor.

6. The system of claim 4, wherein the memory operates to bind data related to hardware of the peripheral device to the transaction instance.

7. The system of claim 1, wherein the logic layer of the web-based service returns a binary result indicating whether the minimum threshold of user authentication has been met.

8. The system of claim 1, wherein the validation data is bar code or quick response (QR) code, the peripheral device comprises at least one camera, and the capturing of the validation data utilizes the at least one camera.

9. The system of claim 1, wherein the logic layer, via at least one application program interface (API), is configured to retrieve data related to at least one of i) device hardware of the peripheral device, ii) which digital payment source of the plurality of digital payment sources has been selected, iii) and whether the peripheral device has data stored for secondary digital payment sources of the one or more digital payment sources.

10. The system of claim 1, wherein the logic layer, via at least one application program interface (API), is configured to retrieve ancillary authentication data selected from i) user faceprint data, ii) user fingerprint data, iii) a user's personal identification number (PIN), iv) a media access control address (MAC), or any combination thereof.

11. A method of authenticating a transaction comprising:
initiating a web-based service in response to capturing validation data from a payment terminal or a point of sale device;
presenting, via the web-based service, a plurality of digital payment sources to a user via a display of a peripheral device;
receiving a selection, via a user input of the peripheral device, of an initial digital payment source of the plurality of digital payment sources to process a transaction associated with the validation data;
receiving a determination by a logic layer of the web-based service whether the selected initial digital payment source is associated with a minimum threshold of user authentication criteria; and
if the minimum threshold of user authentication criteria is not satisfied, i) obtaining user authentication data associated with one or more secondary digital payment sources of the plurality of digital payment sources and associating the user authentication data with the initial digital payment source; or ii) prompting the user to perform one or more authentication actions.

12. The method of claim 11, wherein the transaction includes a request to process a transaction value above a predetermined threshold value.

13. The method of claim 11, wherein the plurality of digital payment sources include one or more crypto-wallets and/or one or more digital currency exchange accounts or applications.

14. The method of claim 11, wherein, if the minimum threshold of user authentication is satisfied, the transaction is processed and the web-based service stores, via a memory of at least one remote server or cloud-based storage device, a transaction instance, wherein the transaction instance includes at least one of i) a transaction identification (ID), ii) identification data related to the initial digital payment source, and iii) meta data related to an identity of the user.

15. The method of claim 14, wherein the memory operates to form a record keeping environment for all transactions from the user and includes a transaction number that is unique to a third party payment processor.

16. The method of claim 14, wherein the memory operates to bind data related to hardware of the peripheral device to the transaction instance.

17. The method of claim 11, wherein the logic layer of the web-based service returns a binary result indicating whether the minimum threshold of user authentication has been met.

18. The method of claim 1, wherein the logic layer, via at least one application program interface (API), is configured to retrieve data related to at least one of i) device hardware of the peripheral device, ii) which digital payment source of the plurality of digital payment sources has been selected, iii) and whether the peripheral device has data stored for secondary digital payment sources of the plurality of digital payment sources.

19. The method of claim 1, wherein the logic layer, via at least one application program interface (API), is configured to retrieve ancillary authentication data selected from i) user faceprint data, ii) user fingerprint data, iii) a user's personal identification number (PIN), iv) a media access control address (MAC), or any combination thereof.

20. A method of authenticating a transaction comprising:
initiating a web-based service in response to capturing a bar code or Quick Response (QR) code from a payment terminal or a point of sale device;
presenting, via the web-based service, one or more crypto-wallets and/or one or more digital currency exchange accounts or applications to a user via a display of a peripheral device;
receiving a selection, via a user input of the peripheral device, of the one or more crypto-wallets and/or the one or more digital currency exchange accounts or applications to process a transaction associated with the validation data;
receiving a determination by a logic layer of the web-based service whether the selected one or more crypto-wallets and/or the one or more digital currency exchange accounts or applications are associated with a minimum threshold of user authentication criteria; and
if the minimum threshold of user authentication criteria is not satisfied, i) obtaining user authentication data associated with one or more secondary crypto-wallets and/or one or more secondary digital currency exchange accounts or applications and associating the user authentication data with the crypto-wallet and/or the one or more digital currency exchange accounts or applications; or ii) prompting the user to perform one or more authentication actions.
